(19) United States
(12) Patent Application Publication
(10) Pub. No.: US 2019/0393746 A1
(43) Pub. Date: Dec. 26, 2019

(54) ROTOR AND MOTOR

(71) Applicant: Nidec Corporation, Kyoto (JP)

(72) Inventors: Shinji TAKEMOTO, Kyoto (JP); Tomoya UEDA, Kyoto (JP); Yusuke ISOGAI, Kyoto (JP)

(21) Appl. No.: 16/402,460

(22) Filed: May 3, 2019

(30) Foreign Application Priority Data
Jun. 22, 2018 (JP) 2018-119145

(51) Int. Cl. H02K 1/27; H02K 15/03; H02K 29/03; H02K 21/16; H02K 1/24; H02K 1/28; H02K 16/02; H01H 50/16

(52) U.S. Cl. CPC H02K 1/276; H02K 15/03; H02K 29/03; H02K 21/16; H02K 2201/06; H02K 1/28; H02K 16/02; H01H 50/16; H02K 1/246

(57) ABSTRACT

A rotatable about a center axis includes a rotor core including an annular inner core portion extending along a circumferential direction, and outer core portions spaced apart along the circumferential direction on an outer side in a radial direction of the inner core portion, magnets each positioned between the outer core portions adjacent to each other in the circumferential direction, and a support that supports the rotor core and the magnet. The support includes an inner support portion that supports the magnet on an inner side in a radial direction of the magnet, an outer support portion that supports the magnet on an outer side in a radial direction of the magnet, and a bridge portion that extends in the radial direction to connect the inner support portion and the outer support portion. The outer core portion includes a penetrating portion that penetrates the outer core portion in the radial direction. At least a portion of the bridge portion is positioned inside the penetrating portion.

### CROSS REFERENCE TO RELATED APPLICATION

The present invention claims priority under 35 U.S.C. § 119 to Japanese Application No. 2018-119145 filed on Jun. 22, 2018, the entire contents of which are incorporated herein by reference.

### FIELD OF THE INVENTION

The present disclosure relates to a rotor and a motor.

### BACKGROUND

There is known a rotor in which yoke portions are provided between multiple permanent magnets arranged along the circumferential direction.

In the configuration as described above, the magnetic flux may leak from the protrusion, and the torque of the motor including the rotor may decrease. Meanwhile, instead of providing a protrusion in the yoke portion, a resin support, for example, may be provided to suppress the permanent magnet from jumping out. However, in this case, insufficient strength of the support may deform the support and shift the position of the permanent magnet.

The strength of the support can be improved by increasing the thickness of the support, for example. However, this may increase the size of the rotor.

### SUMMARY

In view of the foregoing, example embodiments of the present disclosure provide rotors each improving the strength of a support while avoiding increases in size, and motors including such rotors.

A rotor according to an example embodiment of the present disclosure is a rotor rotatable about a center axis and including a rotor core that includes an annular inner core portion extending along a circumferential direction, and multiple outer core portions spaced apart along the circumferential direction on an outer side in a radial direction of the inner core portion, multiple magnets each positioned between the outer core portions adjacent to each other in the circumferential direction, and a support that supports the rotor core and the magnet. The support includes an inner support portion that supports the magnet on an inner side in a radial direction of the magnet, an outer support portion that supports the magnet on an outer side in the radial direction of the magnet, and a bridge portion that extends in the radial direction to connect the inner support portion and the outer support portion. The outer core portion includes a penetrating portion that penetrates the outer core portion in the radial direction. At least a portion of the bridge portion is positioned inside the penetrating portion.

A motor according to an example embodiment of the present disclosure includes the rotor described above.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view schematically showing a motor of a first example embodiment of the present disclosure.

FIG. 2 is a perspective view showing a rotor of the first example embodiment of the present disclosure.

FIG. 3 is a diagram of the rotor of the first example embodiment of the present disclosure as viewed from above.

FIG. 4 is a cross-sectional view showing the rotor of the first example embodiment of the present disclosure, taken along line IV-IV in FIG. 3.

FIG. 5 is a cross-sectional view showing the rotor of the first example embodiment of the present disclosure, taken along line V-V in FIG. 3.

FIG. 6 is a perspective view showing a support of the first example embodiment of the present disclosure.

FIG. 7 is a perspective view showing a portion of a rotor of a second example embodiment of the present disclosure.

FIG. 8 is a cross-sectional view showing a portion of a rotor of a modification of the second example embodiment of the present disclosure.

### DETAILED DESCRIPTION

A Z-axis direction appropriately shown in each drawing is a vertical direction where the positive side is “upper side” and the negative side is “lower side”. A center axis J appropriately shown in each drawing is a virtual line parallel to the Z-axis direction and extending in the vertical direction. In the following description, an axial direction of the center axis J, that is, a direction parallel to the vertical direction is simply referred to as “axial direction”, radial directions centered on the center axis J are simply referred to as “radial direction”, and a circumferential direction about the center axis J is simply referred to as “circumferential direction”. In the example embodiment, the upper side corresponds to one side in the axial direction, and the lower side corresponds to the other side in the axial direction.

Note that the vertical direction, the upper side, and the lower side are simply terms for explaining the positional relationship and the like of the parts, and the actual positional relationship and the like may be a positional relationship or the like referred to by different terms.

### First Example Embodiment

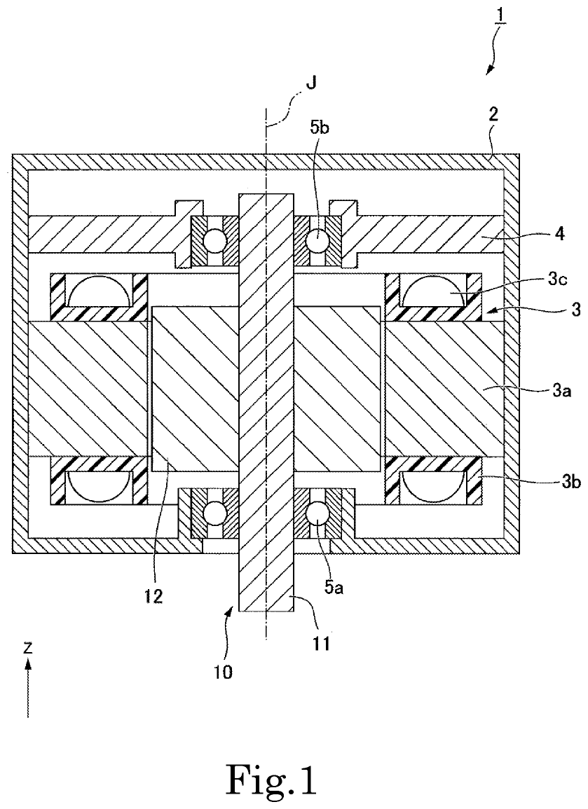

As shown in FIG. 1, a motor 1 of the example embodiment includes a housing 2, a rotor 10, a stator 3, a bearing holder 4, and bearings 5a and 5b. The housing 2 accommodates the rotor 10, the stator 3, the bearing holder 4 and the bearings 5a and 5b. The stator 3 is positioned on the outer side in the radial direction of the rotor 10. The stator 3 has a stator core 3a, an insulator 3b, and multiple coils 3c. The multiple coils 3c are attached to the stator core 3a through the insulator 3b. The bearing holder 4 holds the bearing 5b.

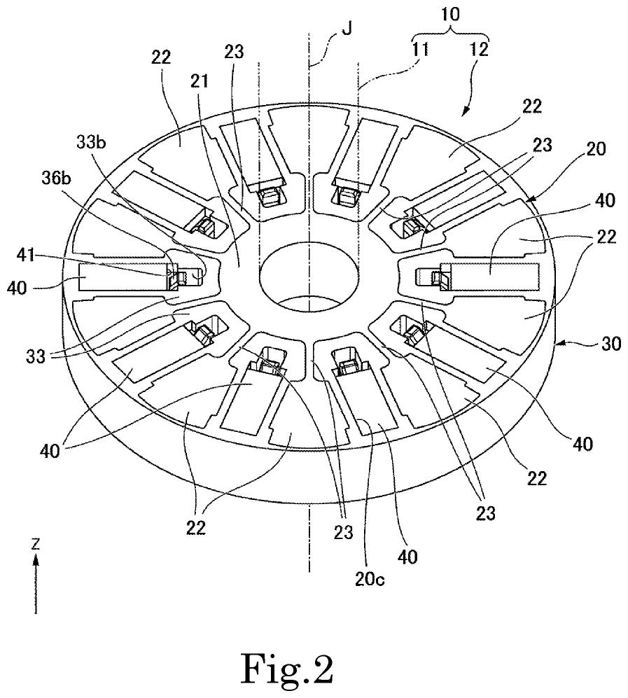

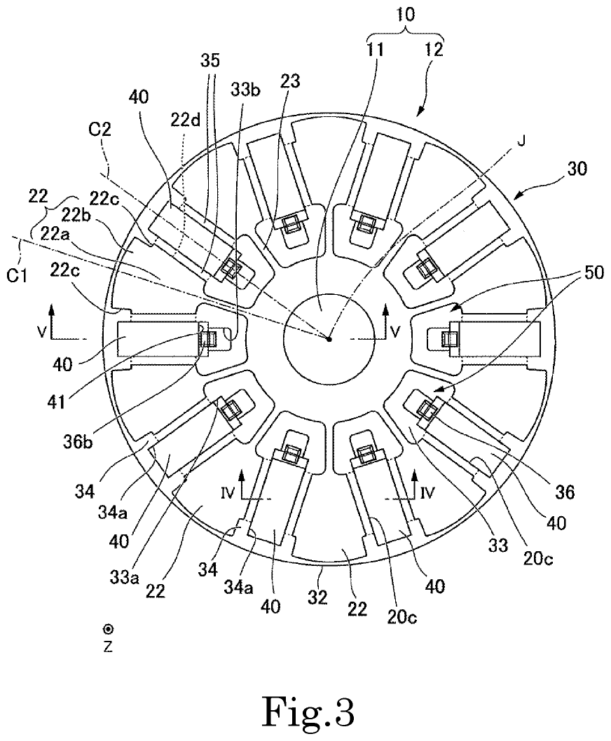

The rotor 10 of the example embodiment is rotatable about the center axis J. The rotor 10 includes a shaft 11 and a rotor main body 12. The shaft 11 has a columnar shape extending in the axial direction around the center axis J. The shaft 11 is supported so as to be rotatable around the center axis J by the bearings 5a and 5b. The rotor main body 12 is fixed to an outer circumferential surface of the shaft 11. As shown in FIGS. 2 and 3, the rotor main body 12 includes a rotor core 20, multiple magnets 40, and a support 30. That is, the rotor 10 includes the rotor core 20, the multiple magnets 40, and the support 30.

The rotor core 20 has an inner core portion 21, multiple outer core portions 22, and multiple connection portions 23. The inner core portion 21 has an annular shape extending along the circumferential direction. In the example embodiment, the inner core portion 21 has a ring shape centered on the center axis J. The shaft 11 is inserted on the inner side in the radial direction of the inner core portion 21. The inner core portion 21 and the shaft 11 are fixed by press fitting, for example.

The multiple outer core portions 22 are spaced apart along the circumferential direction on the outer side in the radial direction of the inner core portion 21. In the example embodiment, the multiple outer core portions 22 are arranged at equal intervals over the entire circumference along the circumferential direction. For example, ten outer core portions 22 are provided. The outer core portion 22 is separated to the outer side in the radial direction of the inner core portion 21.

FIG. 3 shows a circumferential center line C1 as a virtual line passing through the center of the outer core portion 22 in the circumferential direction. The circumferential center line C1 extends radially in a direction passing through the center of the outer core portion 22 in the circumferential direction. The outer core portion 22 extends in the radial direction along the circumferential center line C1. FIG. 3 also shows a circumferential center line C2 as a virtual line passing through the center of the magnet 40 in the circumferential direction. The circumferential center line C2 extends radially in a direction passing through the center of the magnet 40 in the circumferential direction. In the following description, in the outer core portion 22, the side away from the circumferential center line C1 in the circumferential direction is referred to as “outer side in the circumferential direction”, and the side closer to the circumferential center line C1 in the circumferential direction is referred to as “inner side in the circumferential direction”.

As shown in FIG. 3, the outer core portion 22 has an inner portion 22a and an outer portion 22b. The size in the circumferential direction of the inner portion 22a increases toward the outer side in the radial direction. Both side surfaces in the circumferential direction of the inner portion 22a are parallel to the axial direction and are flat surfaces inclined with respect to each other. Both of the side surfaces in the circumferential direction of the inner portion 22a are inclined so as to spread outward in the circumferential direction toward the outer side in the radial direction in axial view.

The outer portion 22b is positioned on the outer side in the radial direction of the inner portion 22a. A radially inner end portion of the outer portion 22b is connected to a radially outer end portion of the inner portion 22a. The radially inner end portion of the outer portion 22b is smaller in the circumferential direction than the radially outer end portion of the inner portion 22a. As a result, stepped portions 22c recessed inward in the circumferential direction from inner to outer sides in the radial direction are provided on both side surfaces of the outer core portion 22 in the circumferential direction. The size in the circumferential direction of the outer portion 22b increases toward the outer side in the radial direction. Both side surfaces in the circumferential direction of the outer portion 22b are parallel to the axial direction and are flat surfaces inclined with respect to each other. Both of the side surfaces in the circumferential direction of the outer portion 22b are inclined so as to spread outward in the circumferential direction toward the outer side in the radial direction in axial view.

The side surface on one side in the circumferential direction of the inner portion 22a and the side surface on one side in the circumferential direction of the outer portion 22b are parallel to each other. The side surface on the other side in the circumferential direction of the inner portion 22a and the side surface on the other side in the circumferential direction of the outer portion 22b are parallel to each other. In the example embodiment, the side surface on one side in the circumferential direction of the inner portion 22a and the side surface on one side in the circumferential direction of the outer portion 22b are parallel to the circumferential center line C2 of the magnet 40 adjacent to one side in the circumferential direction of the outer core portion 22. In the example embodiment, the side surface on the other side in the circumferential direction of the inner portion 22a and the side surface on the other side in the circumferential direction of the outer portion 22b are parallel to the circumferential center line C2 of the magnet 40 adjacent to the other side in the circumferential direction of the outer core portion 22.

A radially outer end surface of the outer core portion 22 is a curved surface which protrudes radially outward in axial view. The radially outer end surface of the outer core portion 22 curves radially inwards toward the outer side in the circumferential direction from the circumferential center line C1. In the example embodiment, the radially outer end surface of the outer core portion 22 is a radially outer end surface of the outer portion 22b.

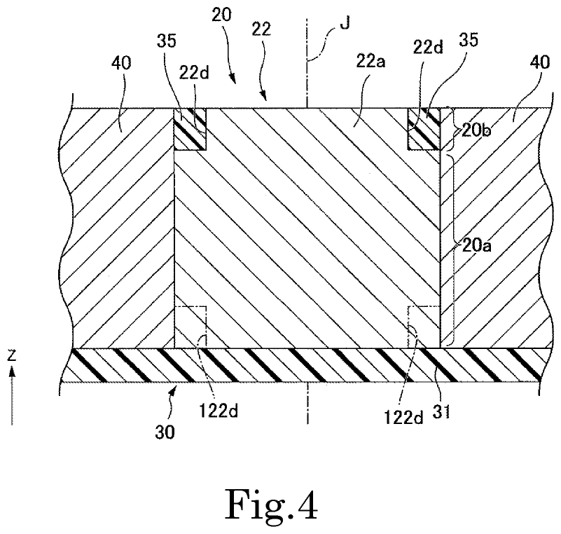

As shown in FIGS. 3 and 4, the outer core portion 22 has a penetrating portion 22d penetrating the outer core portion 22 in the radial direction. In the example embodiment, the penetrating portion 22d is a groove on an upper end surface of the outer core portion 22. The penetrating portion 22d is provided at each of circumferential end portions of the upper end surface of the outer core portion 22. In the example embodiment, the penetrating portion 22d is provided at each of circumferential end portions of an upper end surface of the inner portion 22a. Each of the penetrating portions 22d provided on both sides in the circumferential direction is recessed downward and open toward the outer side in the circumferential direction. As a result, stepped portions recessed downward are provided at both of the circumferential end portions of the upper end surface of the inner portion 22a. The penetrating portion 22d on one side in the circumferential direction linearly extends in a direction parallel to the circumferential center line C2 of the magnet 40 adjacent to one side in the circumferential direction of the outer core portion 22. The penetrating portion 22d on the other side in the circumferential direction linearly extends in a direction parallel to the circumferential center line C2 of the magnet 40 adjacent to the other side in the circumferential direction of the outer core portion 22. The penetrating portions 22d provided on both sides in the circumferential direction are located at the same position in the axial direction.

As shown in FIG. 3, each connection portion 23 extends radially outward from a radially outer side surface of the inner core portion 21, and is connected to a radially inner end portion of a corresponding one of the outer core portions 22. The connection portion 23 is arranged along the circumferential center line C1. The connection portion 23 connects the inner core portion 21 and the outer core portion 22. The multiple connection portions 23 are arranged at equal intervals over the entire circumference along the circumferential direction. For example, ten connection portions 23 are provided. The size in the circumferential direction of the connection portion 23 is smaller than the size in the circumferential direction of the radially inner end portion of the outer core portion 22. In the example embodiment, the size in the circumferential direction of the connection portion 23 is the same in the entire radial direction.

In the example embodiment, the rotor core 20 is formed by laminating multiple electromagnetic steel plates in the axial direction. The electromagnetic steel plate that forms the rotor core 20 includes two types of electromagnetic steel plates which are an electromagnetic steel plate forming a first laminated portion 20a and an electromagnetic steel plate forming a second laminated portion 20b shown in FIG. 4. The first laminated portion 20a is a portion of the rotor core 20 below the penetrating portion 22d. The second laminated portion 20b is a portion of the rotor core 20 where the penetrating portion 22d is provided in the axial direction. The second laminated portion 20b is laminated on the upper side of the first laminated portion 20a. The second laminated portion 20b is an upper end portion of the rotor core 20. As described above, in the example embodiment, the penetrating portions 22d provided on both sides in the circumferential direction are located at the same position in the axial direction. Hence, by merely laminating two types of electromagnetic steel plates which are an electromagnetic steel plate forming a portion where the penetrating portion 22d is provided and an electromagnetic steel plate forming a portion where the penetrating portion 22d is not provided, it is possible to create the rotor core 20 provided with the penetrating portion 22d on both sides in the circumferential direction. Accordingly, it is easy to manufacture the rotor core 20.

The multiple magnets 40 are permanent magnets. As shown in FIG. 3, each of the multiple magnets 40 is positioned between the outer core portions 22 adjacent to each other in the circumferential direction. The magnet 40 has a substantially rectangular parallelepiped shape extending in the radial direction along the circumferential center line C2. As shown in FIG. 4, both side surfaces in the circumferential direction of the magnet 40 are in contact with the circumferential side surfaces of the circumferentially adjacent outer core portions 22. The size in the axial direction of the magnet 40 is the same as the size in the axial direction of the rotor core 20. An upper end surface of the magnet 40 and an upper end surface of the rotor core 20 are positioned on the same plane orthogonal to the axial direction. A lower end surface of the magnet 40 and a lower end surface of the rotor core 20 are positioned on the same plane orthogonal to the axial direction. As shown in FIG. 3, a radially outer end portion of the magnet 40 is positioned on the inner side in the radial direction of a radially outer end portion of the outer core portion 22. A radially inner end portion of the magnet 40 is positioned on the inner side in the radial direction of the radially inner end portion of the outer core portion 22. The magnet 40 is separated to the outer side in the radial direction of the inner core portion 21.

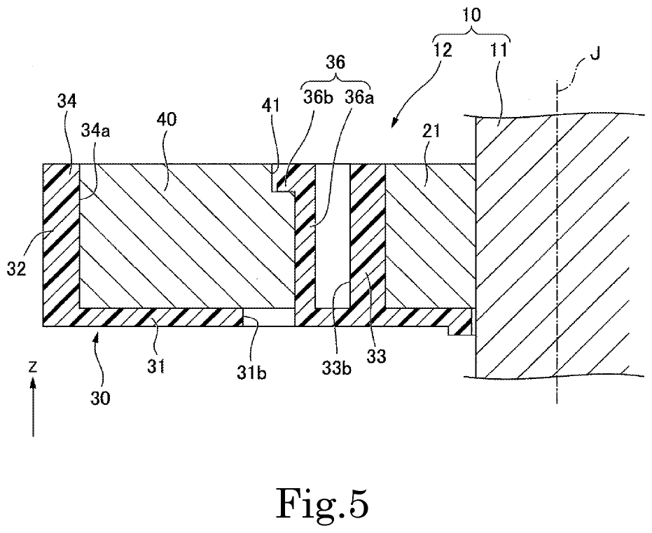

As shown in FIG. 5, the magnet 40 has a magnet recess 41 recessed downward. In the example embodiment, the magnet recess 41 is provided at a radially inner end portion of the upper end surface of the magnet 40. The magnet recess 41 is open toward the inner side in the radial direction. As shown in FIGS. 2 and 3, the magnet recess 41 extends linearly from an end on one side to an end on the other side in the circumferential direction of the magnet 40. By providing the magnet recess 41, a stepped portion recessed downward is provided at the radially inner end portion of the upper surface of the magnet 40. In the example embodiment, the magnet recess 41 is provided in a portion of the magnet 40 that is on the inner side in the radial direction of the outer core portion 22.

The magnet 40 has an N pole and an S pole as magnetic poles arranged along the circumferential direction. The magnets 40 adjacent to each other in the circumferential direction both have the same magnetic poles facing each other in the circumferential direction. That is, of a pair of magnets 40 adjacent to each other in the circumferential direction, if the magnetic pole on the other side in the circumferential direction of the magnet 40 positioned on one side in the circumferential direction is an N pole, for example, the magnetic pole on one side in the circumferential direction of the magnet 40 positioned on the other side in the circumferential direction is an N pole. In this case, the outer core portion 22 between the pair of magnets 40 is excited to an N pole. If the magnetic pole on the other side in the circumferential direction of the magnet 40 positioned on one side in the circumferential direction is an S pole, for example, the magnetic pole on one side in the circumferential direction of the magnet 40 positioned on the other side in the circumferential direction is an S pole. In this case, the outer core portion 22 between the pair of magnets 40 is excited to an S pole. The outer core portion 22 excited to the N pole and the outer core portion 22 excited to the S pole are arranged alternately along the circumferential direction.

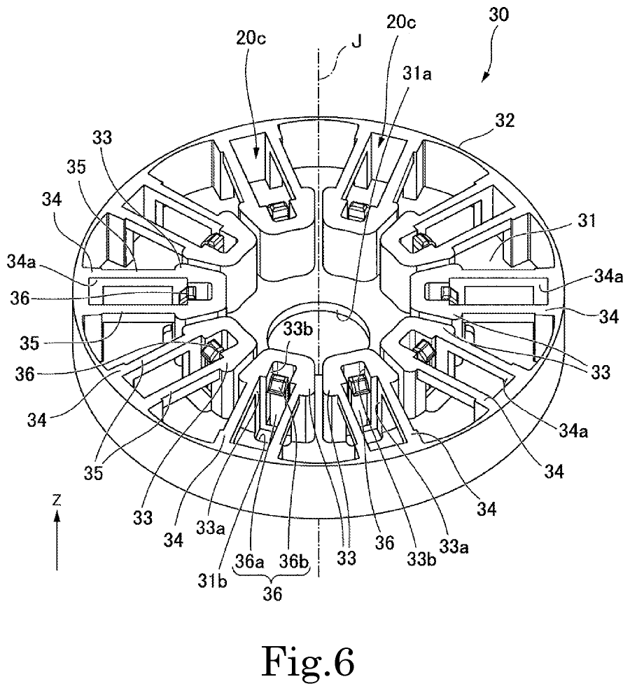

The support 30 supports the rotor core 20 and the magnets 40. In the example embodiment, the support 30 is made of resin. As shown in FIG. 6, the support 30 includes a bottom plate portion 31, an annular wall portion 32, an inner support portion 33, an outer support portion 34, a bridge portion 35, and a snap-fit portion 36.

The bottom plate portion 31 has a plate shape in which a plate surface faces the axial direction. In the example embodiment, the bottom plate portion 31 has a disk shape centered on the center axis J. The bottom plate portion 31 has a through hole 31a axially penetrating a central portion of the bottom plate portion 31. The through hole 31a has a circular shape centered on the center axis J. The shaft 11 is inserted into the through hole 31a. As shown in FIG. 4, the bottom plate portion 31 supports the magnet 40 on the lower side of the magnet 40. The bottom plate portion 31 also supports the rotor core 20 on the lower side of the rotor core 20. An upper surface of the bottom plate portion 31 is in contact with a lower surface of the magnet 40 and a lower surface of the rotor core 20.

As shown in FIG. 6, the annular wall portion 32 has a cylindrical shape protruding upward from a radially outer peripheral edge portion of the bottom plate portion 31. In the example embodiment, the annular wall portion 32 is has a cylindrical shape centered on the center axis J. As shown in FIG. 3, the annular wall portion 32 surrounds the rotor core 20 on the outer side in the radial direction of the rotor core 20. The annular wall portion 32 surrounds the magnet 40 on the outer side in the radial direction of the magnet 40.

As shown in FIG. 6, the inner support portion 33 has a columnar shape protruding upward from the bottom plate portion 31. The inner support portion 33 has a substantially trapezoidal shape with rounded corners, the size in the circumferential direction thereof increasing toward the outer side in the radial direction in axial view. Multiple inner support portions 33 are spaced apart along the circumferential direction. The multiple inner support portions 33 are arranged at equal intervals over the entire circumference along the circumferential direction. For example, ten inner support portions 33 are provided. As shown in FIG. 2, each of the multiple inner support portions 33 is positioned between adjacent connection portions 23 in the circumferential direction. A circumferential side surface of the inner support portion 33 is in contact with a circumferential side surface of the connection portion 23.

Each of the multiple inner support portions 33 is positioned between the inner core portion 21 and a corresponding one of the magnets 40 in the radial direction. A radially inner side surface of the inner support portion 33 has a shape extending along a radially outer side surface of the inner core portion 21, and is in contact with the radially outer side surface of the inner core portion 21. End portions on both sides in the circumferential direction of a radially outer end portion of the inner support portion 33 are in contact with a radially inner side surface of the outer core portion 22.

As shown in FIG. 6, the inner support portion 33 has a first inner recess 33a recessed radially inward from the radially outer end portion of the inner support portion 33. The first inner recess 33a extends in the axial direction and opens on both sides in the axial direction. An opening on the lower side of the first inner recess 33a is connected to a later-mentioned hole 31b. As shown in FIG. 3, the radially inner end portion of the magnet 40 is fitted and fixed to the first inner recess 33a. Both side surfaces in the circumferential direction at the radially inner end portion of the magnet 40 are respectively in contact with surfaces on both sides in the circumferential direction of an inside surface of the first inner recess 33a. As a result, the inner support portion 33 supports the magnet 40 on the inner side in the radial direction of the magnet 40. The inner support portion 33 can suppress circumferential movement of the radially inner end portion of the magnet 40. The inner support portion 33 has a second inner recess 33b recessed radially inward from a radially inner surface of the inside surface of the first inner recess 33a. The second inner recess 33b is open toward the upper side.

As shown in FIG. 6, the outer support portion 34 is provided on the radially inner side surface of the annular wall portion 32. The outer support portion 34 has a columnar shape that protrudes radially inward from the radially inner side surface of the annular wall portion 32 and extends in the axial direction. A lower end portion of the outer support portion 34 is connected to the upper surface of the bottom plate portion 31. As a result, the inner support portion 33 and the outer support portion 34 are connected through the bottom plate portion 31. That is, the bottom plate portion 31 connects the inner support portion 33 and the outer support portion 34. Multiple outer support portions 34 are spaced apart along the circumferential direction. The multiple outer support portions 34 are arranged at equal intervals over the entire circumference along the circumferential direction. For example, ten outer support portions 34 are provided. Each of the outer support portions 34 is positioned on the outer side in the radial direction of a corresponding one of the inner support portions 33. Each of the outer support portions 34 is positioned on the outer side in the radial direction of a corresponding one of the magnets 40.

The outer support portion 34 has an outer recess 34a recessed radially outward from a radially inner end portion of the outer support portion 34. As shown in FIG. 3, the radially outer end portion of the magnet 40 is fitted and fixed to the outer recess 34a. Both side surfaces in the circumferential direction at the radially outer end portion of the magnet 40 are respectively in contact with surfaces on both sides in the circumferential direction of an inside surface of the outer recess 34a. As a result, the outer support portion 34 supports the magnet 40 on the outer side in the radial direction of the magnet 40. The outer support portion 34 can suppress circumferential movement of the radially outer end portion of the magnet 40. Since the magnet 40 is supported by the inner support portion 33 and the outer support portion 34 in this manner, it is possible to suppress radial and circumferential movement of the magnet 40. A radially outer side surface of the magnet 40 is in contact with a radially outer surface of the inside surface of the outer recess 34a.

As shown in FIG. 6, the bridge portion 35 extends in the radial direction and connects the inner support portion 33 and the outer support portion 34. Hence, both the strength of the inner support portion 33 and the strength of the outer support portion 34 can be improved. As a result, deformation of the inner support portion 33 and the outer support portion 34 supporting the magnet 40 can be suppressed, and displacement of the magnet 40 can be avoided.

The bridge portion 35 has a long and narrow rectangular parallelepiped shape, for example. In the example embodiment, two bridge portions 35 are provided for each pair of inner support portion 33 and outer support portion 34 arranged side by side in the radial direction. The bridge portions 35 extend radially outward from both edges in the circumferential direction of the first inner recess 33a of the radially outer side surface of the inner support portion 33, and are connected to both edges in the circumferential direction of the outer recess 34a of the radially inner side surface of the outer support portion 34. In the example embodiment, the two bridge portions 35 provided for a pair of inner support portion 33 and outer support portion 34 extend in the radial direction parallel to the circumferential center line C2 of the magnet 40 positioned between the two bridge portions 35, and are parallel to each other. In the example embodiment, the bridge portion 35 connects an upper end portion of the inner support portion 33 and an upper end portion of the outer support portion 34.

As shown in FIG. 4, at least a part of the bridge portion 35 is positioned inside the penetrating portion 22d. Hence, even if the bridge portion 35 is provided, upsizing of the rotor 10 can be avoided. As a result, according to the example embodiment, it is possible to improve the strength of the support 30 by connecting the inner support portion 33 and the outer support portion 34 by the bridge portion 35, while avoiding upsizing of the rotor 10. Hence, displacement of the magnet 40 can be avoided. As a result, an increase in the cogging torque in the motor 1 can be suppressed, and a decrease in the torque of the motor 1 can be suppressed. In addition, the bridge portion 35 can support the outer core portion 22 in the axial direction. Hence, it is possible to suppress axial movement of the rotor core 20 with respect to the support 30.

Further, according to the example embodiment, the penetrating portion 22d is provided at the circumferential end portion of the outer core portion 22. Hence, deterioration of the magnetic characteristics of the outer core portion 22 can be suppressed more securely than when the penetrating portion 22d is provided in the circumferential center or the like of the outer core portion 22.

Further, according to the example embodiment, the annular wall portion 32 is provided, and the outer support portion 34 is provided on the radially inner side surface of the annular wall portion 32. Hence, the annular wall portion 32 can improve the strength of the outer support portion 34. As a result, the magnet 40 can be more stably held. In the example embodiment, the annular wall portion 32 connects multiple outer support portions 34.

Further, according to the example embodiment, the bottom plate portion 31 connecting the inner support portion 33 and the outer support portion 34 is provided. Hence, it is possible to further improve the strength of the inner support portion 33 and the strength of the outer support portion 34. As a result, the strength of the support 30 can be improved even more. Further, the bottom plate portion 31 can support the magnet 40 from below. Consequently, the magnet 40 can be more stably held.

Further, according to the example embodiment, the support 30 is made of resin. Hence, labor and cost for manufacturing the support 30 can be reduced. Also, when the support 30 is made of resin, the strength of the support 30 tends to be lower than when the support 30 is made of metal. For this reason, the above-described effect of improving the strength of the support 30 is particularly useful when the support 30 is made of resin as in the example embodiment.

In the example embodiment, the whole bridge portion 35 is positioned inside the penetrating portion 22d. In the example embodiment, the bridge portion 35 is provided on both sides in the circumferential direction of the outer core portion 22. Hence, the bridge portion 35 is provided on both sides in the circumferential direction of the magnet 40 as well. As a result, it is possible to further improve the strength of the inner support portion 33 and the outer support portion 34 supporting each magnet 40. Accordingly, the magnet 40 can be more stably held. In the example embodiment, the bridge portion 35 is provided on both sides in the circumferential direction of the outer core portion 22 in the second laminated portion 20b. The bridge portion 35 is in contact with the outer core portion 22 and the magnet 40 of the second laminated portion 20b, and is thereby sandwiched in the circumferential direction.

In the example embodiment, as described above, the penetrating portion 22d is a groove on the upper end surface of the outer core portion 22. Hence, the bridge portion 35 is positioned on the upper side of the outer core portion 22. As a result, the outer core portion 22 can be pressed from the upper side by the bridge portion 35, and the outer core portion 22 can be kept from coming off the support 30 to the upper side. In the example embodiment, since the bottom plate portion 31 is provided, it is possible to support by sandwiching the outer core portion 22 in the axial direction by the bottom plate portion 31 and the bridge portion 35. As a result, it is possible to further suppress axial movement of the outer core portion 22 with respect to the support 30.

The upper end portion of the bridge portion 35 is located at the same position in the axial direction as the upper end portion of the rotor core 20. Hence, even if the bridge portion 35 is provided, the rotor 10 is not upsized in the axial direction. As a result, it is possible to more surely avoid upsizing of the rotor 10. In the example embodiment, an upper end surface of the support 30, the upper end surface of the rotor core 20, and the upper end surface of the magnet 40 are positioned on the same plane orthogonal to the axial direction.

As shown in FIG. 5, the snap-fit portion 36 extends upward from a lower surface of an inside surface of the second inner recess 33b. The snap-fit portion 36 has an extending portion 36a extending in the axial direction, and a claw portion 36b protruding radially outward from an upper end portion of the extending portion 36a. The extending portion 36a extends upward from the lower surface of the inside surface of the second inner recess 33b. The extending portion 36a has a plate shape whose plate surface faces in the radial direction. The claw portion 36b is hooked on the magnet 40 from the above. Accordingly, the snap-fit portion 36 fixes the magnet 40 to the support 30 by snap fitting. Hence, it is possible to more stably hold the magnet 40 on the support 30. Further, an adhesive or the like is not required to fix the magnet 40, and the magnet 40 can be easily fixed to the support 30.

In the example embodiment, the claw portion 36b is hooked on a bottom surface of the magnet recess 41. In the example embodiment, the bottom surface of the magnet recess 41 is an upper surface of the inside surface of the magnet recess 41. With this configuration, it is possible to keep the claw portion 36b from protruding upward from the magnet 40. As a result, even if the snap-fit portion 36 is provided, it is possible to avoid upsizing of the rotor 10 in the axial direction. In the example embodiment, an upper end portion of the snap-fit portion 36 is located at the same position in the axial direction as an upper end portion of the magnet 40. Hence, even if the snap-fit portion 36 is provided, the rotor 10 is not upsized in the axial direction. Further, in the example embodiment, the magnet recess 41 is provided in a portion of the magnet 40 on the inner side in the radial direction of the outer core portion 22. Hence, even if the magnet recess 41 is provided, it is possible to suppress deterioration of the magnetic flux from the magnet 40 for exciting the outer core portion 22. As a result, it is possible to suppress reduction in the torque of the motor 1.

Further, according to the example embodiment, the snap-fit portion 36 is provided on the inner support portion 33. Hence, it is easier to arrange the magnet 40 on the outer side in the radial direction than when the snap-fit portion 36 is provided on the outer support portion 34, for example. As a result, the outer core portion 22 can be suitably excited by the magnet 40, and the torque of the motor 1 can be suitably obtained.

The snap-fit portion 36 applies an elastic force to the magnet 40 in a radially outward direction, for example. As a result, the snap-fit portion 36 presses the magnet 40 against the radially outer surface of the inside surface of the outer recess 34a. Accordingly, the outer support portion 34 and the snap-fit portion 36 can sandwich the magnet 40 in the radial direction while being in contact with the magnet 40. Hence, it is possible to further suppress radial movement of the magnet 40.

The support 30 has a hole 31b penetrating the support 30 in the axial direction. In the example embodiment, the hole 31b is provided in the bottom plate portion 31. The hole 31b penetrates the bottom plate portion 31 in the axial direction. The hole 31b overlaps the claw portion 36b in axial view. The entire claw portion 36b overlaps the hole 31b in axial view. Hence, when the support 30 is formed from resin by using two upper and lower divided dies, the portion of the die for making the claw portion 36b can be easily pulled up and down through the hole 31b. Accordingly, it is easy to form the snap-fit portion 36.

As shown in FIGS. 2, 3, and 6, the rotor 10 includes a magnet housing portion 20c accommodating the magnet 40, configured of the bottom plate portion 31, the inner support portion 33, the outer support portion 34, the two bridge portions 35, and a pair of outer core portions 22 adjacent to each other in the circumferential direction. The magnet housing portion 20c is open toward the upper side. Multiple magnet housing portions 20c are provided along the circumferential direction.

As shown in FIG. 3, in the rotor 10 of the example embodiment, a flux barrier portion 50 is provided between the magnet 40 and the inner core portion 21 in the radial direction. The flux barrier portion 50 is a portion that can suppress movement of magnetic flux from the inner core portion 21 to the magnet 40 or from the magnet 40 to the inner core portion 21. The flux barrier portion 50 may include a hollow portion or a non-magnetic portion, as long as the movement of magnetic flux can be suppressed. In the example embodiment, the flux barrier portion 50 includes the inner support portion 33, the snap-fit portion 36, and the inside of the second inner recess 33b. By providing the flux barrier portion 50, it is possible to suppress leakage of magnetic flux from the magnet 40 to the inner side in the radial direction. Hence, the outer core portion 22 can be suitably excited by the magnet 40.

In the example embodiment, the support 30 is made by insert molding using the rotor core 20 as an insert member. As a result, the rotor core 20 is embedded in the support 30, and the support 30 and the rotor core 20 are formed integrally. The aforementioned multiple magnet housing portions 20c are provided in the integrally formed support 30 and rotor core 20. After forming the support 30 in which the rotor core 20 is embedded by insert molding, the magnet 40 is inserted into the magnet housing portion 20c from above. At this time, the snap-fit portion 36 is elastically deformed radially inward by the magnet 40. In the example embodiment, since the second inner recess 33b is provided, the radially inward deformation of the snap-fit portion 36 can be released by the second inner recess 33b. After the magnet 40 comes into contact with the bottom plate portion 31 and is completely accommodated in the magnet housing portion 20c, the snap-fit portion 36 is restored, and the claw portion 36b is hooked on the magnet 40. Thus, the magnet 40 is fixed to the support 30.

### Second Example Embodiment

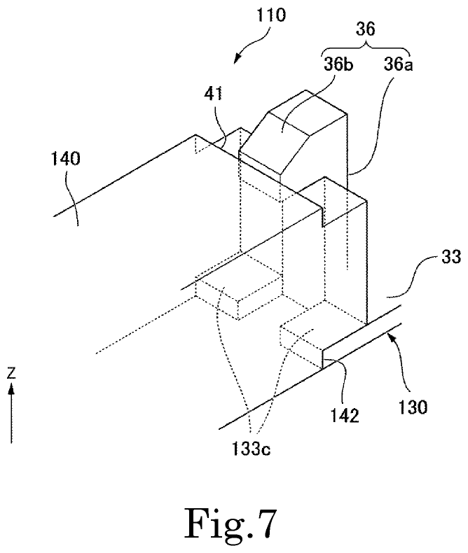

As shown in FIG. 7, in a rotor 110 of the example embodiment, a magnet 140 has a lower recess 142. The lower recess 142 is recessed upward from a radially inner end portion of a lower surface of the magnet 140. The lower recess 142 has the same shape as the magnet recess 41 except that it is inverted.

In the example embodiment, unlike the first example embodiment, a support 130 does not have the bottom plate portion 31. The support 130 has a pair of magnet support portions 133c protruding radially outward from an inner support portion 33. The pair of magnet support portions 133c are provided on portions of a lower end portion of the inner support portion 33 on both sides in the circumferential direction of a snap-fit portion 36. The magnet support portion 133c supports the magnet 140 from below. As a result, even if the bottom plate portion 31 is not provided, it is possible to support the magnet 140 from both sides in the axial direction by the support 130. A lower surface of the magnet 140 is exposed to the outside of the support 130.

In the example embodiment, the rotor core also has a penetrating portion 122d on both sides in the circumferential direction of a lower end portion, for example, as indicated by the two-dot chain line in FIG. 4. The penetrating portion 122d has the same shape as the penetrating portion 22d except that it is inverted. That is, in the example embodiment, the penetrating portion is provided on the end surfaces on both axial sides of the outer core portion. A bridge portion 35 is inserted through the penetrating portion 122d in the same manner as the penetrating portion 22d. Thus, in this example embodiment, the bridge portion is provided on both axial sides of the outer core portion. Accordingly, even if the bottom plate portion 31 is not provided, the rotor core can be supported from both sides in the axial direction by the support 130.

Further, in the example embodiment, since the bottom plate portion 31 is not provided, the lower surface of the rotor core has an exposed portion. That is, in the example embodiment, the surfaces on both axial sides of the rotor core have portions exposed in the axial direction. By thus not providing the bottom plate portion 31, it is possible to downsize the rotor 110 in the axial direction.

### Modification of Second Example Embodiment

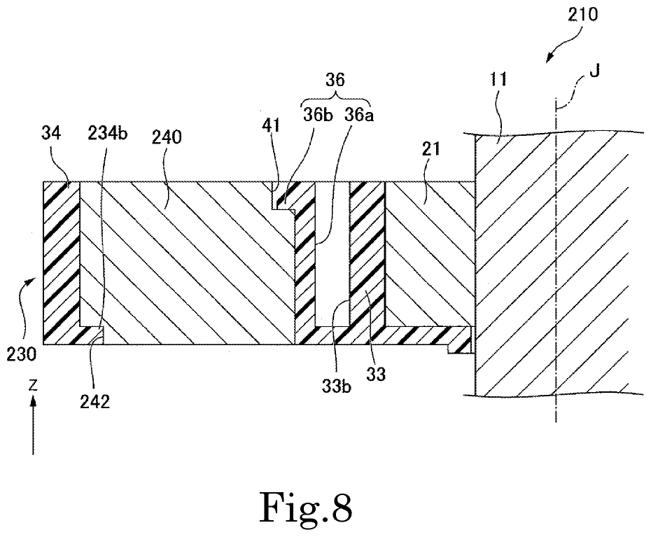

As shown in FIG. 8, in a rotor 210 of this modification, a lower recess 242 of a magnet 240 is provided at a radially outer end portion of a lower surface of the magnet 240. A magnet supporting portion 234b of a support 230 protrudes radially inward from a lower end portion of an outer support portion 34. The magnet supporting portion 234b supports the magnet 240 from below. As a result, it is possible to support the magnet 240 from both sides in the axial direction by the support 230.

The present disclosure is not limited to the above-described example embodiment, and other configurations may be adopted. The penetrating portion is not particularly limited as long as it penetrates the outer core portion in the radial direction. The penetrating portion may be provided in the center in the circumferential direction of the outer core portion, or may be provided in the center in the axial direction of the outer core portion. The penetrating portion may be a hole penetrating the outer core portion instead of the groove. The penetrating portions respectively provided at end portions on both sides in the circumferential direction of the outer core portion may have different shapes, or may be located in different positions in the axial direction. The penetrating portion may be provided only at an end portion on one side in the circumferential direction of the outer core portion. One penetrating portion may be provided for each outer core portion, or three or more penetrating portions may be provided for each outer core portion.

The bridge portion is not particularly limited, as long as it connects the inner support portion and the outer support portion and at least a part thereof is positioned inside the penetrating portion. One, or three or more bridge portions may be provided for each pair of the inner support portion and outer support portion. The shape of the bridge portion is not particularly limited. The upper end portion of the bridge portion may be positioned lower than the upper end portion of the rotor core. In this case, too, even if the bridge portion is provided, the rotor is not upsized in the axial direction.

The support is not particularly limited as long as it has an inner support portion, an outer support portion, and a bridge portion. The material of the support is not particularly limited. The support may be made of metal. The annular wall portion may be omitted. In this case, since the radially outer side surface of the rotor core can be brought closer to the stator, the torque of the motor can be improved easily. The snap-fit portion may be omitted.

Applications of the rotor and the motor according to the example embodiment described above are not particularly limited. The rotor and the motor according to the above-described example embodiment are mounted on, for example, a vehicle, an unmanned mobile unit, an electric assist device, a robot device, and the like. Note that the configurations described in this specification can be appropriately combined only to the extent that they do not contradict with each other.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotor rotatable about a center axis, the rotor comprising:
a rotor core including an annular inner core portion extending along a circumferential direction, and a plurality of outer core portions spaced apart along the circumferential direction on an outer side in a radial direction of the inner core portion;
a plurality of magnets each positioned between the outer core portions adjacent to each other in the circumferential direction; and
a support that supports the rotor core and the magnet; wherein
the support includes:
an inner support portion that supports the magnet on an inner side in a radial direction of the magnet;
an outer support portion that supports the magnet on an outer side in the radial direction of the magnet; and
a bridge portion extending in a radial direction to connect the inner support portion and the outer support portion;
the outer core portion includes a penetrating portion that penetrates the outer core portion in the radial direction; and
at least a portion of the bridge portion is positioned inside the penetrating portion.

2. The rotor according to claim 1, wherein the penetrating portion is provided at an end portion in the circumferential direction of the outer core portion.

3. The rotor according to claim 2, wherein
the penetrating portion is provided at both end portions in the circumferential direction of the outer core portion; and
the bridge portion is provided on both sides in the circumferential direction of the outer core portion.

4. The rotor according to claim 1, wherein
the support includes an annular wall portion that surrounds the rotor core on an outer side in a radial direction of the rotor core; and
the outer support portion is provided on a radially inner side surface of the annular wall portion.

5. The rotor according to claim 1, wherein
the support includes a snap-fit portion that fixes the magnet to the support by snap fitting; and
the snap-fit portion includes a claw portion that is hooked on the magnet from one side in the axial direction.

6. The rotor according to claim 5, wherein
the magnet includes a magnet recess recessed to another side in the axial direction; and
the claw portion is hooked on a bottom surface of the magnet recess.

7. The rotor according to claim 5, wherein the snap-fit portion is provided on the inner support portion.

8. The rotor according to claim 5, wherein
the snap-fit portion includes an extending portion extending in the axial direction;
the claw portion protrudes in the radial direction from an end portion on one side in the axial direction of the extending portion;
the support includes a hole penetrating the support in the axial direction; and
the claw portion entirely overlaps the hole in axial view.

9. The rotor according to claim 1, wherein
the penetrating portion includes a groove on an end surface on one side in the axial direction of the outer core portion; and
the bridge portion is positioned on one side in the axial direction of the outer core portion.

10. The rotor according to claim 9, wherein an end portion on one side in the axial direction of the bridge portion is located at a same position in the axial direction as an end portion on one side in the axial direction of the rotor core, or is located on another side in the axial direction of the end portion on one side in the axial direction of the rotor core.

11. The rotor according to claim 1, wherein
the support includes a bottom plate portion that supports the magnet on the other side in the axial direction of the magnet; and
the bottom plate portion connects the inner support portion and the outer support portion.

12. The rotor according to claim 9, wherein
the penetrating portion is provided on both end surfaces in the axial direction of the outer core portion;
the bridge portion is provided on both sides in the axial direction of the outer core portion; and
surfaces on both sides in the axial direction of the rotor core each includes a portion exposed in the axial direction.

13. The rotor according to claim 1, wherein
a flux barrier portion is provided between the magnet and the inner core portion in the radial direction; and
the flux barrier portion includes the inner support portion.

14. The rotor according to claim 1, wherein the support is made of resin.

15. A motor comprising the rotor according to claim 1.
